(19) United States
(12) Patent Application Publication
(10) Pub. No.: US 2024/0363291 A1
(43) Pub. Date: Oct. 31, 2024

(54) ELECTRODE FOIL FOR SOLID ELECTROLYTIC CAPACITORS, SOLID ELECTROLYTIC CAPACITOR ELEMENT USING SAME, AND SOLID ELECTROLYTIC CAPACITOR

(71) Applicant: Panasonic Intellectual Property Management Co., Ltd., Kadoma-shi, Osaka (JP)

(72) Inventors: Masamichi Inoue, OSAKA FU (JP); Daisuke Usa, OSAKA FU (JP)

(73) Assignee: Panasonic Intellectual Property Management Co., Ltd., Kadoma-shi, Osaka (JP)

(21) Appl. No.: 18/687,008

(22) PCT Filed: Aug. 8, 2022
(86) PCT No.: PCT/JP2022/030229

§ 371 Date: Feb. 27, 2024

(30) Foreign Application Priority Data
Aug. 30, 2021 (JP) 2021-140421

(51) Int. Cl. H01G 9/15; H01G 9/045; H01G 9/055; H01G 9/10

(52) U.S. Cl. CPC H01G 9/15; H01G 9/045; H01G 9/055; H01G 9/10

(57) ABSTRACT

An electrode foil for a solid electrolytic capacitor includes a metal foil, which has a first portion on which a solid electrolyte layer is to be formed and a second portion on which the solid electrolyte layer is not to be formed. The metal foil includes, in at least the first portion, a porous portion and a core portion continuous with the porous portion. In a cross section taken in a direction parallel to the thickness direction of the first portion, the percentage of area occupied by the core portion is 40% or more.

### TECHNICAL FIELD

The present disclosure relates to an electrode foil for a solid electrolytic capacitor, a solid electrolytic capacitor element using the same, and a solid electrolytic capacitor.

### BACKGROUND ART

A solid electrolytic capacitor includes a capacitor element having a solid electrolyte layer, an electrode terminal electrically connected to the capacitor element, and an exterior body that seals the capacitor element. The capacitor element includes an anode foil having a porous portion in a surface layer, a dielectric layer formed on at least a portion of the surface of the anode foil, a solid electrolyte layer covering at least a portion of the dielectric layer, and a cathode extraction layer covering at least a portion of the solid electrolyte layer, for example.

In recent years, as electronic components have decreased in size and increased in performance, there has been increasing demand for smaller size and increased capacity for solid electrolytic capacitors mounted on electronic components. In view of this, in conventional solid electrolytic capacitors, the surface area of the anode foil is increased in order to increase the capacitance without changing the size of the anode foil, thus realizing a smaller size and increased capacitance for the electrolytic capacitor (e.g., Patent Literature 1).

On the other hand, there is demand for solid electrolytic capacitors to have a low equivalent series resistance (ESR). For example, Patent Literature 2 proposes a solid electrolytic capacitor in which a plurality of capacitor elements are stacked, wherein a foil, which is a conductive foil made of a conductive material and having noble metal portions on the upper and lower surfaces, is electrically connected to the end portion of the anode portion of each of the capacitor elements, and the noble metal portions are electrically connected to each other via a conductive adhesive. Patent Literature 3 proposes a solid electrolytic capacitor in which at least a portion of the cathode layer is constituted of a silver layer, wherein the silver layer is made of silver nanoparticles and silver particles bonded together by an organic binder, and the relative average particle size of the silver particles is 100 to 2,500 times that of the silver nanoparticles.

### CITATION LIST

### Patent Literature

PTL 1: Japanese Laid-Open Patent Publication No. H9-148200
PTL 2: Japanese Laid-Open Patent Publication No. 2008-205108
PTL 3: Japanese Laid-Open Patent Publication No. 2006-253169

### SUMMARY OF INVENTION

### Technical Problem

In solid electrolytic capacitors, the ESR tends to increase as the capacitance increases. For this reason, in order to reduce the ESR while suppressing influence on the capacitance, it is often the case that the connection method is improved as in Patent Literature 2, or that the resistance of the cathode extraction layer is lowered as in Patent Literature 3.

### Solution to Problem

A first aspect of the present disclosure relates to an electrode foil for a solid electrolytic capacitor, including: a metal foil having a first portion on which a solid electrolyte layer is to be formed and a second portion on which the solid electrolyte layer is not to be formed,
wherein the metal foil includes, in at least the first portion, a porous portion and a core portion continuous with the porous portion, and in a cross section of the first portion taken in a direction parallel to a thickness direction, a percentage of area occupied by the core portion is 40% or more.

A second aspect of the present disclosure relates to a solid electrolytic capacitor element including:
the above-described electrode foil for a solid electrolytic capacitor, as an anode foil;
a dielectric layer formed on at least a portion of a surface of the anode foil; and
a cathode portion covering at least a portion of the dielectric layer,
wherein the cathode portion includes, in the first portion, at least the solid electrolyte layer covering at least a portion of the dielectric layer.

A third aspect of the present disclosure relates to a solid electrolytic capacitor including at least one solid electrolytic capacitor element described above.

### Advantageous Effects of Invention

The ESR of a solid electrolytic capacitor can be reduced.

### BRIEF DESCRIPTION OF DRAWINGS

FIG. 1 A schematic cross-sectional view of a solid electrolytic capacitor according to an embodiment of the present disclosure.

FIG. 2 A cross-sectional view schematically showing a solid electrolytic capacitor element included in the solid electrolytic capacitor shown in FIG. 1.

### DESCRIPTION OF EMBODIMENTS

While novel features of the present invention are set forth in the appended claims, both the configuration and content of the present invention, as well as other objects and features of the present application, will be better understood from the following detailed description given with reference to the drawings.

ESR is often reduced by lowering the resistance of the cathode extraction layer or by improving the electrical connections between components of a solid electrolytic capacitor. Conventionally, almost no improvements have been made to the electrode foil used as the anode foil from the perspective of reducing ESR.

In view of such common knowledge, the inventors of the present invention found that the ESR of a solid electrolytic capacitor can be reduced by adjusting the percentage of area occupied by the core portion in a cross section of the metal foil constituting an electrode foil for a solid electrolytic capacitor. More specifically, in the metal foil constituting the electrode foil for a solid electrolytic capacitor of the present disclosure, the percentage of area occupied by the core portion is 40% or more in a cross section taken in a direction parallel to the thickness direction of at least a first portion. In other words, the percentage of the volume of the core portion in the metal foil is relatively large. By using such a metal foil as the electrode foil (anode foil), a high conductivity can be obtained for the electrode foil, and the ESR can be reduced. (1) An electrode foil for a solid electrolytic capacitor according to a first aspect of the present disclosure is an electrode foil for a solid electrolytic capacitor, including: a metal foil having a first portion on which a solid electrolyte layer is to be formed and a second portion on which the solid electrolyte layer is not to be formed,
wherein the metal foil includes, in at least the first portion, a porous portion and a core portion continuous with the porous portion, and in a cross section of the first portion taken in a direction parallel to a thickness direction, a percentage of area occupied by the core portion is 40% or more.

Also, due to the metal foil including the porous portion in addition to the core portion, it is possible to ensure an appropriate capacitance for the solid electrolytic capacitor. This makes it possible to ensure excellent charge/discharge response for the solid electrolytic capacitor. Also, due to the area percentage (volume percentage) of the core portion being relatively high, the amount of air that passes through the porous portion from the second portion side is relatively small. This therefore suppresses deterioration of the solid electrolyte layer caused by the influence of oxygen or moisture contained in the air. Such deterioration of the solid electrolyte layer becomes particularly noticeable when the solid electrolytic capacitor is exposed to a high temperature environment. In the present disclosure, even when the solid electrolytic capacitor is exposed to a high temperature environment, deterioration of the solid electrolyte layer is suppressed, thus making it possible to suppress a decrease in capacitance.

The present disclosure also encompasses (2) a solid electrolytic capacitor element including the above-described electrode foil for a solid electrolytic capacitor as an anode foil, and (3) a solid electrolytic capacitor including at least one solid electrolytic capacitor element described above. More specifically, the solid electrolytic capacitor element according to aspect (2) includes the electrode foil for a solid electrolytic capacitor according to aspect (1) as an anode foil, a dielectric layer formed on at least a portion of the surface of the anode foil, and a cathode portion covering at least a portion of the dielectric layer, and the cathode portion includes, in the first portion, at least a solid electrolyte layer covering at least a portion of the dielectric layer.

(4) In any one of aspects (1) to (3), in the first portion, a total thickness of the porous portion may be 60 μm or less.

(5) In any one of aspects (1) to (4), in the first portion, a thickness of the core portion may be 30 μm or more.

(6) In any one of aspects (1) to (5), in the first portion, the porous portion may have a porosity of 60% or more and 80% or less in a center portion, with respect to the thickness direction, of the porous portion.

Hereinafter, an electrode foil for a solid capacitor, a solid electrolytic capacitor element, and a solid electrolytic capacitor of the present disclosure will be described in more detail, including the above aspects (1) to (6), with reference to the drawings as necessary. At least one of the above aspects (1) to (6) and at least one of the elements described below may be combined within a technically consistent range.

### [Solid Electrolytic Capacitor]

A solid electrolytic capacitor includes one or more solid electrolytic capacitor elements. Hereinafter, the solid electrolytic capacitor element may be simply referred to as a capacitor element.

### (Capacitor Element)

### (Electrode Foil for Solid Electrolytic Capacitor (Anode Foil))

The capacitor element includes an anode foil that is constituted of a metal foil containing a valve metal, an alloy containing a valve metal, a compound containing a valve metal, or the like. The metal foil may contain one of such materials or a combination of two or more of such materials. Examples of valve metals include aluminum, tantalum, niobium, and titanium. Among these, it is preferable that the metal foil contains aluminum (including an alloy or a compound thereof).

The metal foil has a first portion on which a solid electrolyte layer is formed and a second portion on which the solid electrolyte layer is not formed. In the first portion, a cathode portion that includes a solid electrolyte layer is formed via a dielectric layer, and therefore the first portion is sometimes called the cathode forming portion. The second portion is sometimes called the anode lead-out portion. An anode lead is connected to the second portion.

The metal foil has, in at least the first portion, a porous portion and a core portion that is continuous with the porous portion. The porous portion is formed in a portion that includes at least the surface layer of the metal foil. The metal foil may have a core portion like a layer and a porous portion formed on the surface of the core portion, for example. The porous portion may be formed on one surface of the core portion, or may be formed on both surfaces of the core portion. Preferably, the porous portion is formed over the whole of the first portion in a length direction of the first portion. Normally, the core portion is formed over the whole of the first portion in the length direction of the first portion (preferably the whole of the metal foil in a length direction of the metal foil). Note that the core portion can be said to be the non-porous portion of the metal foil (or electrode foil). The core portion may be referred to as the portion of the metal foil (or electrode foil) other than the porous portion.

In this specification, the anode foil has a first end portion, which is the end portion of the first portion on the side opposite to the second portion, and a second end portion, which is the end portion of the second portion on the side opposite to the first end portion (that is to say, end on the side opposite to the first end portion). The direction from the first end portion of the metal foil constituting the anode foil to the second end portion is defined as the length direction of the metal foil (anode foil). Also, when the main surface of the metal foil (anode foil) is viewed from a direction perpendicular to the main surface, the direction perpendicular to the length direction of the anode foil is defined as the width direction of the anode foil. The width direction of the anode foil is also perpendicular to the thickness direction of the anode foil. The direction from the first end portion to the second end portion is a direction parallel to the direction of a straight line connecting the centers of end surfaces of the anode foil on the first end portion side and the second end portion side. The length direction of the first portion and the length direction of the second portion are each parallel to the length direction of the metal foil (or anode foil). The thickness direction of the first portion and the thickness direction of the second portion are parallel to the thickness direction of the metal foil (or anode foil).

In the present disclosure, in a cross section of the first portion taken in a direction parallel to the thickness direction, the percentage of area occupied by the core portion is 40%, and may be 43% or more. If the area percentage of the core portion is within this range, the effect of reducing the ESR of the solid electrolytic capacitor is obtained, and excellent charge/discharge response is also obtained. It is also possible to suppress a decrease in capacitance after the solid electrolytic capacitor is exposed to a high temperature environment. From the viewpoint of easily ensuring high capacitance, the area percentage of the core portion is preferably 60% or less, and may be 50% or less or 48% or less. These upper limit values and lower limit values can be combined in any combinations. The area percentage of the core portion is 40% or more and 60% or less (or 50% or less), and may be 43% or more and 48% or less, for example.

Note that the area percentage of the core portion is determined for the entire cross section taken parallel to the thickness direction of the first portion of the metal foil. This cross section is a cross section that passes through the center of the metal foil in the width direction. The area percentage of the core portion and the thicknesses of the core portion and porous portion can be determined using a cross-sectional image of the metal foil (anode foil) before formation of the solid electrolyte layer, a cross-sectional image of the solid electrolytic capacitor, or a cross-sectional image of the capacitor element, which is acquired using a scanning electron microscope (SEM).

The area percentage of the core portion need only be within the above range at least in the first portion, and there is no particular limitation on the area percentage of the core portion in the second portion. The area percentage of the core portion in the second portion may be the same as that in the first portion. Also, a configuration is possible in which the second portion does not have a porous portion (that is to say, the second portion may be entirely constituted of the core portion). For example, the portion of the second portion on the second end side may be entirely constituted by the core portion, and the second portion on the first end side may be provided with the core portion and the porous portion similarly to the first portion.

In the first portion, the thickness of the core portion is 28 μm or more, for example. From the viewpoint of further improving the ESR reduction effect and charge/discharge response, the thickness of the core portion in the first portion is preferably 30 μm or more. From the viewpoint of easily achieving a balance between high capacitance and low ESR, the thickness of the core portion is preferably 60 μm or less, or more preferably 56 μm or less. These upper limit values and lower limit values can be combined in any combinations. The thickness of the core portion in the first portion may be 28 μm or more and 60 μm or less, 30 μm or more and 60 μm or less, or 30 μm or more and 56 μm or less, for example. The thickness of the core portion may be the average value of values measured at a plurality of optional locations (e.g., at five locations) in the cross section for measuring the area percentage of the core portion.

In the first portion, the total thickness of the porous portion is 75 μm or less, for example. From the viewpoint of easily ensuring better charge/discharge response, the total thickness of the porous portion in the first portion is preferably 60 μm or less, and may be 55 μm or less or 52 μm or less. From the viewpoint of easily securing higher capacitance, the total thickness of the porous portion in the first portion is preferably 35 μm or more, or more preferably 40 μm or more. These upper limit values and lower limit values can be combined in any combinations. The total thickness of the porous portion in the first portion may be 35 μm or more and 75 μm or less, 40 μm or more and 55 μm or less, or 40 μm or more and 52 μm or less, for example. Note that in the case where the porous portion is formed on one surface of the core portion, the total thickness of the porous portion is the thickness of that porous portion, whereas in the case where the porous portion is formed on both surfaces of the core portion, the total thickness of the porous portion is the sum of the thicknesses of the porous portions on both surfaces. The total thickness of the porous portion may be the average value of values measured at a plurality of optional locations (e.g., at five locations) in the cross section for measuring the area percentage of the core portion.

In the present disclosure, the area percentage of the core portion is increased in the first portion, and therefore the area percentage of the porous portion is relatively smaller. For this reason, from the viewpoint of ensuring higher capacitance, it is preferable that the porosity of the porous layer is high. In particular, if many voids are formed in not only the surface layer of the porous portion but also inside the porous portion, the specific surface area of the anode foil becomes larger, and it is easier to secure higher capacitance, and furthermore, if the solid electrolyte layer is formed so as to penetrate into the porous portion, it is possible to improving an effect of reducing the intrusion of air from the second portion side. Therefore, it is possible to further suppress a decrease in capacitance when the solid electrolytic capacitor is exposed to a high temperature environment, which is even more advantageous in ensuring high reliability.

More specifically, the porosity in a center portion, with respect to the thickness direction, of the porous portion in the first portion is preferably 60% or more. If the porous portion has a high porosity even in the center portion in the thickness direction in this way, the solid electrolyte layer can be easily formed so as to further penetrate into the porous portion, even higher capacitance can be ensured, and even higher reliability can be ensured. The porosity in the center portion in the thickness direction of the porous portion is preferably 80% or less, and may be 76% or less. When the porosity is within this range, the solid electrolyte layer can be easily held within the pores of the porous portion, which is advantageous from the viewpoint of increasing capacity. These upper limit values and lower limit values can be combined in any combinations. The porosity in the center portion in the thickness direction of the porous portion in the first portion may be 60% or more and 80% or less, or 60% or more and 76% or less, for example.

In the first portion, the porosity of the porous portion near the surface layer is 75% or more and 85% or less, and may be 80% or more and 85% or less, for example.

In the first portion, the porosity near the core portion of the porous portion may be 40% or more and 55% or less, for example. The porosity near the core portion is preferably 45% or more and 55% or less. By obtaining a high porosity of 45% or more even near the core portion, it is easy to ensure a high porosity from the vicinity of the core portion to the surface layer of the porous portion. Therefore, the solid electrolyte layer is likely to be formed so as to extend to the vicinity of the core portion of the porous portion, and a higher capacity can be obtained.

The porosity of the porous portion in the center portion in the thickness direction, near the surface layer, and near the core portion can be measured by a procedure such as the following.

The porosity can be determined using the cross-sectional image used to measure the area percentage of the core portion. More specifically, first, the cross-sectional image is binarized in order to distinguish between the metal (including an alloy or a metal compound) constituting the anode foil and the other portion corresponding to voids (corresponding to pores (pits)). In the binarized cross-sectional image, an area S0 of the porous portion formed on one surface of the core portion in the first portion is determined, then letting a thickness of 0% correspond to the surface of this porous portion, and letting a thickness of 100% correspond to the interface between the porous portion and the core portion, an area S1 of the portion where the thickness is 40% or more and 50% or less is obtained, and the ratio of S1 to S0=S1/S0×100(%) is obtained. This area percentage is regarded as the volume-based porosity in the center portion in the thickness direction of the porous portion in the first portion of the metal foil (or anode foil). The porosity of the porous portion near the surface layer is determined as the ratio (%) of an area S2, which is the area of a portion having a thickness of 20% or more and 30% or less, to S0, similarly to the case of the center portion. The porosity of the porous portion in the vicinity of the core portion is determined as the ratio (%) of an area S3, which is the area of the portion having a thickness of 90% or more and 100% or less, to S0, similarly to the case of the center portion.

The metal foil may have, between the first end portion and the second end portion, a region where the porous portion is not formed in the thickness direction, a region where a portion of the porous portion has been removed, or a region where a portion of the porous portion has been compressed, if necessary. Note that the thickness of the core portion and the thickness of the porous portion are measured in a portion other than these regions.

The shape of the pores (pits) in the porous portion may be sponge-like or tunnel-like, for example. The concept of a tunnel-like pit includes a pit extending from the surface side of the porous portion toward the core portion side. The core portion can also be said to be a portion of the anode foil that does not have such pores.

An insulating separating portion for ensuring insulation between the anode side and the cathode portion side may be provided between the first end portion and the second end portion of the anode foil. In the portion where the separating portion is provided, the porous portion may be compressed, or at least a portion of the porous portion may be removed, if necessary. The separating portion may be formed by adhering insulating tape or the like, or may be formed by applying an insulating resin (e.g., a thermosetting resin composition) or the like to the anode foil, or both of such techniques may be used. The separating portion may be formed on the surface of the anode foil, or may be formed in a state of soaking into the porous portion of the anode foil, or both of such techniques may be used. Preferably, the area percentage of the core portion, the thickness of the porous portion, the thickness of the core portion, and the pore diameter of the porous portion are measured in a portion other than the portion where the separating portion is provided.

The electrode foil is formed by roughening the surface of a base material (e.g., a sheet-like (e.g., foil-like, plate-like) base material) containing a valve metal, for example. The surface roughening can be performed by etching, for example. The porous portion of the electrode foil is the outer portion of the metal foil made porous by etching, and the remaining portion, which is the inward portion of the metal foil, is the core portion.

The etching may be performed by chemical etching, for example. If electrolytic etching is performed, the porosity inside the porous portion can be easily increased. By adjusting the etching conditions, it is possible to adjust the area percentage of the core portion, the thicknesses of the core portion and the porous portion, the porosity of the porous portion, and the state of the voids, for example.

Examples of the etching solution include an aqueous solution containing hydrochloric acid and at least one selected from the group consisting of sulfuric acid, nitric acid, phosphoric acid, and oxalic acid. The aqueous solution may contain any of various additives such as a chelating agent. The concentration of hydrochloric acid in the etching solution is 1 mol/L or more and 10 mol/L or less, for example. The concentration of other acids in the etching solution is 0.01 mol/L or more and 1 mol/L or less, for example.

The current density in the electrolytic etching is 0.01 A/cm² or more and 10 A/cm² or less, and may be 0.05 A/cm² or more and 5 A/cm² or less, for example. Etching may be performed with a constant current density or with varying current density.

The electrolytic etching may be performed by direct current etching, but from the viewpoint of being able to easily increase the porosity inside the porous portion, it is preferable that the electrolytic etching is performed by alternating current etching.

In the alternating current etching, the frequency is 5 Hz or more and 50 Hz or less, and may be 10 Hz or more and 35 Hz or less, for example.

The temperature of the etching solution in the electrolytic etching step is 5° C. or more and 60° C. or less, for example.

The etching time is 1 minute or more and 30 minutes or less, and may be 1 minute or more and 15 minutes or less, for example.

The metal foil subjected to etching may be pre-processed if necessary. The pre-processing can be performed by immersing the metal foil in an aqueous solution containing an acid such as phosphoric acid, for example. The temperature of the aqueous solution may be 50° C. or more and 100° C. or less, for example. The immersion time is 10 seconds or more and 5 minutes or less, for example.

The metal foil may be subjected to post-processing after the etching, if necessary. The post-processing can be performed by immersion in an aqueous solution containing an acid such as sulfuric acid, for example. The temperature of the aqueous solution may be 50° C. or more and 100° C. or less, for example. The immersion time is 10 seconds or more and 5 minutes or less, for example. The metal foil may be subjected to heating after the post-processing, if necessary. In the heating, the metal foil is heated at a temperature of 150° C. or higher and 280° C. or lower, for example. The heating time is 10 seconds or more and 5 minutes or less, for example.

### (Dielectric Layer)

The dielectric layer is an insulating layer that functions as a dielectric, and is formed so as to cover at least a portion of the surface of the anode foil. The dielectric layer is formed by anodizing the valve metal on the surface of the anode foil by chemical conversion processing or the like. It is sufficient that the dielectric layer is formed so as to cover at least a portion of the anode foil. Normally, the dielectric layer is formed at the surface of the anode foil. Since the dielectric layer is formed at the porous surface of the anode foil, the surface of the dielectric layer has fine protrusions and recessions as described above.

The dielectric layer contains an oxide of the valve metal. For example, when tantalum is used as the valve metal, the dielectric layer contains Ta₂O₅, and when aluminum is used as the valve metal, the dielectric layer contains Al₂O₃. Note that the dielectric layer is not limited to this, and need only be a layer that functions as a dielectric.

### (Solid Electrolyte Layer)

The solid electrolyte layer is formed on the surface of the anode foil so as to cover the dielectric layer, with the dielectric layer interposed therebetween. The solid electrolyte layer does not necessarily need to cover the entirety (the entire surface) of the dielectric layer, and need only be formed so as to cover at least a portion of the dielectric layer. The solid electrolyte layer constitutes at least a portion of the cathode portion in the solid electrolytic capacitor.

The solid electrolyte layer contains a conductive polymer. The solid electrolyte layer may further contain at least either a dopant or an additive, if necessary.

The conductive polymer can be a known material used in solid electrolytic capacitors, such as a π-conjugated conductive polymer. Examples of the conductive polymer include a polymer having a basic skeleton of polypyrrole, polythiophene, polyaniline, polyfuran, polyacetylene, polyphenylene, polyphenylene vinylene, polyacene, or polythiophene vinylene. Among these, a polymer having a basic skeleton of polypyrrole, polythiophene, or polyaniline is preferable. Other examples of the polymer include a homopolymer, a copolymer of two or more types of monomers, and a derivative thereof (e.g., a substituted product having a substituent). For example, polythiophene polymer includes poly(3,4-ethylenedioxythiophene).

The conductive polymer may be used singly or in combination of two or more.

The solid electrolyte layer can further include a dopant. For example, the dopant can be at least one selected from the group consisting of an anion and a polyanion.

Examples of anions include sulfate ions, nitrate ions, phosphate ions, borate ions, organic sulfonate ions, and carboxylate ions, but there is no particular limitation to these examples. Examples of a dopant that generates sulfonic acid ions include benzenesulfonic acid, p-toluenesulfonic acid, and naphthalenesulfonic acid.

Examples of the polyanion include a polymer-type polysulfonic acid and a polymer-type polycarboxylic acid. Examples of the polymer-type polysulfonic acid include polyvinylsulfonic acid, polystyrenesulfonic acid, polyallylsulfonic acid, polyacrylsulfonic acid, and polymethacrylsulfonic acid. Examples of the polymer-type polycarboxylic acid include polyacrylic acid and polymethacrylic acid. Other examples of the polyanion include a polyester sulfonic acid, a phenolsulfonic acid novolac resin, and the like. However, the polyanion is not limited to these examples.

The dopant may be contained in the solid electrolyte layer in a free form, an anionic form, or a salt form, or may be contained in a form bound to or interacting with a conductive polymer.

Based on 100 parts by mass of the conductive polymer, the amount of dopant contained in the solid electrolyte layer is 10 parts by mass or more and 1000 parts by mass or less, or may be 20 parts by mass or more and 500 parts by mass or less, or 50 parts by mass or more and 200 parts by mass, for example.

The solid electrolyte layer may be a single layer or may be constituted of multiple layers. In the case where the solid electrolyte layer is constituted of multiple layers, the conductive polymers contained in the respective layers may be the same or different. Furthermore, the dopants contained in the respective layers may be the same or different.

The solid electrolyte layer may further contain known additives and known conductive materials other than the conductive polymer component, if necessary. Examples of such conductive materials include at least one selected from the group consisting of conductive inorganic materials such as manganese dioxide, and TCNQ complex salts.

Note that a layer for increasing adhesion, for example, may be interposed between the dielectric layer and the solid electrolyte layer.

The solid electrolyte layer is formed by using a processing liquid containing a conductive polymer precursor and polymerizing the precursor on the dielectric layer, for example. Polymerization can be performed by at least either chemical polymerization or electrolytic polymerization. Examples of the conductive polymer precursor include monomers, oligomers, and prepolymers. The solid electrolyte layer may be formed by applying a processing liquid (e.g., a dispersion or solution) containing a conductive polymer to the dielectric layer and then drying it. Examples of the dispersion medium (or solvent) include water, organic solvents, and mixtures thereof. The processing liquid may further contain another component (such as at least one selected from the group consisting of a dopant and an additive).

In the case of using a processing liquid containing a conductive polymer precursor, an oxidizing agent is usually used to polymerize the precursor. The oxidizing agent may be contained in the processing liquid as an additive. Also, the oxidizing agent may be applied to the anode foil before or after bringing the processing liquid into contact with the anode foil on which the dielectric layer has been formed. Examples of such oxidizing agents include compounds capable of producing Fe³⁺ (e.g., ferric sulfate), persulfates (e.g., sodium persulfate, ammonium persulfate), and hydrogen peroxide. The oxidizing agents can be used alone or in combination of two or more.

The step of forming a solid electrolyte layer by immersion in a processing liquid and polymerization (or drying) may be performed once or may be repeated multiple times. Conditions such as the composition and viscosity of the processing liquid may be the same each time, or at least one condition may be changed.

### (Cathode Extraction Layer)

The cathode extraction layer need only include at least a first layer that is in contact with the solid electrolyte layer and covers at least a portion of the solid electrolyte layer, and may include the first layer and a second layer that covers the first layer. Examples of the first layer include a layer containing conductive particles, a metal foil, and the like. Examples of the conductive particles include at least one selected from conductive carbon and a metal powder. For example, the cathode extraction layer may be constituted of a layer containing conductive carbon (also referred to as a carbon layer) as the first layer, and a metal foil or a layer containing a metal powder as the second layer. In the case of using a metal foil as the first layer, the cathode extraction layer may be constituted of the metal foil.

Examples of the conductive carbon include graphite (artificial graphite, natural graphite, or the like).

The layer containing a metal powder serving as the second layer can be formed by laminating a composition containing a metal powder on the surface of the first layer, for example. Examples of such a second layer include a metal paste layer formed using a composition containing a metal powder such as silver particles and a resin (binder resin). Although a thermoplastic resin can be used as the resin, it is preferable to use a thermosetting resin such as an imide-series resin or an epoxy resin.

In the case of using a metal foil as the first layer, there are no particular limitations on the type of metal, but it is preferable to use a valve metal such as aluminum, tantalum, niobium, or an alloy containing a valve metal. If necessary, the surface of the metal foil may be roughened. The surface of the metal foil may be provided with a chemical conversion film, or may be provided with a coating made of a metal different from the metal constituting the metal foil (dissimilar metal) or a non-metal coating. Examples of dissimilar metals and non-metals include metals such as titanium and non-metals such as carbon (e.g., conductive carbon).

The above dissimilar metal or non-metal (e.g., conductive carbon) coating may be used as the first layer, and the above-described metal foil may be used as the second layer.

### (Separator)

In the case of using a metal foil in the cathode extraction layer, a separator may be placed between the metal foil and the anode foil. There are no particular limitations on the separator, and for example, it is possible to use a nonwoven fabric containing fibers of cellulose, polyethylene terephthalate, vinylon, polyamide (e.g., aliphatic polyamide, aromatic polyamide such as aramid), or the like.

### (Other Remarks)

The solid electrolytic capacitor may be of a wound type, a chip type, or a laminated type. The solid electrolytic capacitor need only include at least one capacitor element, and may include a plurality of capacitor elements. For example, the solid electrolytic capacitor may include a stack of two or more capacitor elements. In the case where the solid electrolytic capacitor includes a plurality of capacitor elements, each capacitor element may be of a wound type or a laminated type, for example. The configuration of the capacitor element may be selected depending on the type of solid electrolytic capacitor.

In the capacitor element, one end portion of the cathode lead is electrically connected to the cathode extraction layer. One end portion of the anode lead is electrically connected to the anode foil. The other end portion of the anode lead and the other end portion of the cathode lead are each drawn out from the resin exterior body or case. The other end portions of the leads exposed from the resin exterior body or case are used for solder connection to the substrate on which the solid electrolytic capacitor is to be mounted, for example. Lead wires may be used as the leads, or a lead frame may be used.

The capacitor element is sealed using a resin exterior body or a case. For example, the capacitor element and the exterior body resin material (e.g., uncured thermosetting resin and a filler) may be placed in a mold, and transfer molding, compression molding, or the like may be performed in order to seal the capacitor element in the resin exterior body. At this time, the other end side portion of the anode lead and the other end side portion of the cathode lead, which have been drawn out from the capacitor element, are exposed from the mold. Also, the solid electrolytic capacitor may be formed by placing the capacitor element in a bottomed case such that the other end side portion of the anode lead and the other end side portion of the cathode lead are located on the opening side of the bottomed case, and then sealing the opening of the bottomed case with a sealing body.

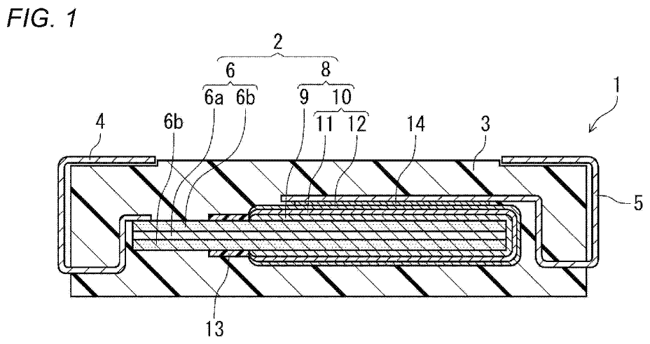

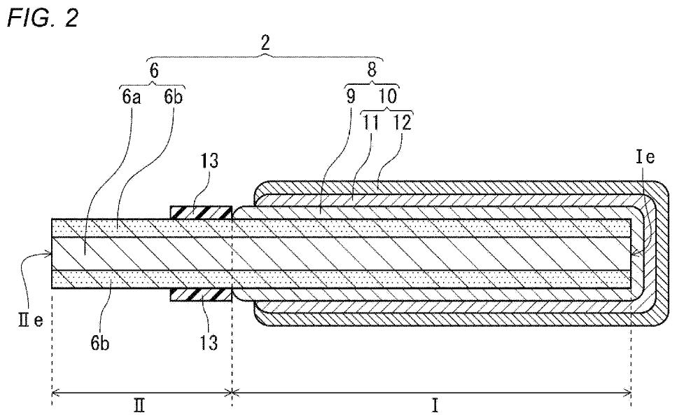

FIG. 1 is a cross-sectional view schematically showing the structure of a solid electrolytic capacitor according to a first embodiment of the present disclosure. FIG. 2 is an enlarged cross-sectional view schematically showing a capacitor element 2 included in the solid electrolytic capacitor of FIG. 1.

A solid electrolytic capacitor 1 includes the capacitor element 2, an exterior body 3 that seals the capacitor element 2, and an anode lead terminal 4 and a cathode lead terminal 5 that are at least partially exposed from the exterior body 3. The exterior body 3 has an approximately rectangular parallelepiped outer shape, and the solid electrolytic capacitor 1 also has an approximately rectangular parallelepiped outer shape.

The capacitor element 2 includes an anode foil 6, a dielectric layer (not shown) covering the surface of the anode foil 6, and a cathode portion 8 covering the dielectric layer. The dielectric layer need only be formed on at least a portion of the surface of the anode foil 6.

The cathode portion 8 includes a solid electrolyte layer 9 and a cathode extraction layer 10. The solid electrolyte layer 9 covers at least a portion of the dielectric layer. The cathode extraction layer 10 is formed so as to cover at least a portion of the solid electrolyte layer 9. The cathode extraction layer 10 has a first layer 11, which is a carbon layer, and a second layer 12, which is a metal paste layer, for example. The cathode lead terminal 5 is electrically connected to the cathode portion 8 via an adhesive layer 14 made of a conductive adhesive.

The anode foil 6 includes a layered core portion 6a and porous portions 6b formed on the two surfaces of the core portion like a layer 6a. The porous portions 6b are formed in a region that includes the surface layer of the anode foil 6. The anode foil 6 includes a first portion I in which the solid electrolyte layer 9 (or the cathode portion 8) is formed (i.e., a portion facing the cathode portion 8), and a second portion II other than the first portion I (i.e., a portion not facing the cathode portion 8). The anode lead terminal 4 is electrically connected to the second portion II by welding. The anode foil 6 has a first end portion Ie, which is a portion of the first portion I on the side opposite to the second portion II, and a second end portion He, which is a portion of the second portion II on the side opposite to the first portion I. The second end portion He is connected to the anode lead terminal 4. An insulating separating portion 13 is formed on the surface of the anode foil 6, in a region between the first end portion Ie and the second end portion He of the anode foil 6, and contact between the cathode portion 8 and the second portion II is restricted.

In the present disclosure, in a cross section taken in a direction parallel to the thickness direction of the metal foil constituting the anode foil 6, as shown in FIG. 2, at least in the first portion I, the percentage of area occupied by the core portion 6a is 40% or more. Accordingly, the ESR can be reduced, and excellent charge/discharge response can be obtained. Also, it is possible to suppress a decrease in capacitance when the solid electrolytic capacitor is exposed to a high temperature environment, and high reliability can be obtained.

The exterior body 3 covers the capacitor element 2 and portions of the lead terminals 4 and 5. From the viewpoint of suppressing the intrusion of air into the exterior body 3, it is desirable that the capacitor element 2 and portions of the lead terminals 4 and 5 are sealed with the exterior body 3. Although FIG. 1 shows a case where the exterior body 3 is a resin exterior body, the exterior body 3 is not limited to this, and may be a case in which the capacitor element 2 can be housed, for example. The resin exterior body is formed by sealing the capacitor element 2 and portions of the lead terminals 4 and 5 with a resin material.

One end portion of the anode lead terminal 4 and one end portion of the cathode lead terminal 5 are electrically connected to the capacitor element 2, and the other end portions are drawn out from the exterior body 3. In the solid electrolytic capacitor 1, the one end sides of the lead terminals 4 and 5 are covered by the exterior body 3, along with the capacitor element 2.

### EXAMPLES

Hereinafter, the present invention will be specifically described based on example and a comparative examples, but the present invention is not limited to the following examples.

### <<Solid Electrolytic Capacitor A1>>

The solid electrolytic capacitor 1 shown in FIG. 1 was manufactured in the following manner, and characteristics thereof were evaluated.

### (1) Preparation of Anode Foil 6

An aluminum foil (thickness 108 μm, purity 99.98%) was pre-processed by immersion in a 90° C. phosphoric acid aqueous solution (phosphoric acid concentration 1.0% by mass) for 60 seconds.

The pre-processed aluminum foil was immersed in an etching solution and electrolytically etched using an AC power source. The etching solution was an aqueous solution containing 5% by mass of hydrochloric acid, 2% by mass of aluminum chloride, 0.1% by mass of sulfuric acid, 0.5% by mass of phosphoric acid, and 0.2% by mass of nitric acid was used, and the solution temperature was 35° C. The etching time was 5 minutes. The frequency of the alternating current was approximately 24 Hz. The average current density of the alternating current was kept constant at 0.2 A/cm².

The aluminum foil was immersed in a 60° C. aqueous solution containing 10% by mass of sulfuric acid for 60 seconds, and then heat-treated at 250° C. for 120 seconds. This thus produced the anode foil 6 in which the porous portions 6b were formed on the two surfaces of the core portion 6a.

### (2) Formation of Dielectric Layer

The anode foil 6 obtained in step (1) was entirely immersed in a chemical solution, and a DC voltage of 70 V was applied for 20 minutes to form a dielectric layer containing aluminum oxide.

### (3) Formation of Solid Electrolyte Layer 9

The separating portion 13 was formed by affixing insulating resist tape to a portion of the anode foil 6 having the dielectric layer formed thereof as described in step (2), specifically in the vicinity of the end portion of the second portion II on the first portion I side. A precoat layer (not shown) was formed by immersing the first portion I of the anode foil 6, in which the separating portion 13 was formed, in a liquid composition containing a conductive material, taking out the first portion I, and then drying the first portion I.

A polymerization solution containing pyrrole (conductive polymer monomer), naphthalene sulfonic acid (dopant), and water was prepared. The first portion I of the anode foil 6, on which the precoat layer was formed, and a Ti electrode serving as a counter electrode were immersed in the polymerization solution, and a voltage was applied to the anode foil such that the potential of the anode foil 6 relative to the silver/silver chloride reference electrode was 2.8 V to perform electrolytic polymerization, thus forming the solid electrolyte layer 9 in the first portion I.

### (4) Formation of Cathode Extraction Layer 10

The anode foil 6, on which the solid electrolyte layer 9 obtained in step (3) was formed, was immersed in a dispersion of graphite particles dispersed in water, taken out from the dispersion, and dried to form the first layer (carbon layer) 11 on at least the surface of the solid electrolyte layer 9. Drying was performed at 130 to 180° C. for 10 to 30 minutes.

Next, a silver paste containing silver particles and a binder resin (epoxy resin) was applied to the surface of the first layer 11, and the binder resin was cured by heating at 150 to 200° C. for 10 to 60 minutes, thus forming the second layer (metal paste layer) 12. In this way, the cathode extraction layer 10 constituted of the first layer 11 and the second layer 12 was formed, and the cathode portion 8 constituted of the solid electrolyte layer 9 and the cathode extraction layer 10 was formed.

The capacitor element 2 was produced as described above.

### (5) Assembly of Solid Electrolytic Capacitor

The cathode portion 8 of the capacitor element 2 obtained in step (4) and one end portion of the cathode lead terminal 5 were joined using an adhesive layer 14 made of a conductive adhesive. The second portion II of the anode foil 6 protruding from the capacitor element 2 and one end portion of the anode lead terminal 4 were joined by laser welding.

Next, a resin exterior body 3 made of an insulating resin was formed around the capacitor element 2 by molding. At this time, the other end portion of the anode lead terminal 4 and the other end portion of the cathode lead terminal 5 were drawn out from the resin exterior body 3.

In this way, the solid electrolytic capacitor 1 (A1) was completed. A total of 20 solid electrolytic capacitors A1 were produced in the same manner as above.

### <<Solid Electrolytic Capacitor B1>>

The anode foil 6 having the core portion 6a and the porous portions 6b formed on the two surfaces of the core portion 6a was formed by using aluminum foil (thickness 82 μm, purity 99.98%) and adjusting the etching conditions (more specifically, at least either the etching time or the frequency of the alternating current). A total of 20 solid electrolytic capacitors B1 were produced in the same manner as in the case of the solid electrolytic capacitor A1, except that the obtained anode foil was used.

### [Evaluation]

For each of the solid electrolytic capacitors A1 and B1, the thickness of the core portion 6a, the total thickness of the porous portion 6b, and the area percentage of the core portion 6a were determined using the previously described procedures.

Also, the initial ESR of each solid electrolytic capacitor was determined using the following procedure.

In an environment of 20° C., the ESR value (mΩ) of the solid electrolytic capacitor at a frequency of 100 kHz was measured as the initial ESR value (X₀) (mΩ) using an LCR meter for 4-terminal measurement, and the average value was calculated for 20 samples. The initial ESR of the solid electrolytic capacitor B1 is shown as a relative value when the initial ESR value of the solid electrolytic capacitor A1 is taken as 100%.

The results are shown in Table 1. Table 1 also shows the thickness of the anode foil. The solid electrolytic capacitor A1 is the working example, and the solid electrolytic capacitor B1 is the comparative example.

TABLE 1

| | A1 | B1 |
|---|---|---|
| Anode foil total thickness (μm) | 108 | 82 |
| Core portion thickness (μm) | 56 | 30 |
| Porous portion thickness (μm) | 26 | 26 |
| Core portion area percentage (%) | 48 | 37 |
| Initial ESR (%) | 100 | 110 |

As shown in Table 1, the solid electrolytic capacitor A1 has a lower initial ESR than the solid electrolytic capacitor B1. This is thought to be because in the solid electrolytic capacitor A1, the area percentage of the core portion is as large as 40% or more, thus obtaining high conductivity in the anode foil. There was almost no difference in the state of the porous portions between the solid electrolytic capacitors A1 and B1, and the same level of capacitance was secured.

### <<Solid Electrolytic Capacitor A2>>

The anode foil 6 was prepared in the same manner as in the case of the solid electrolytic capacitor A1, except that aluminum foil (thickness 70 μm, purity 99.98%) was used, and the etching conditions (more specifically, at least either the etching time or the frequency of the alternating current) were adjusted. A total of 20 solid electrolytic capacitors A2 were produced in the same manner as in the case of the solid electrolytic capacitor A1, except that the obtained anode foil 6 was used.

### <<Solid Electrolytic Capacitor B2>>

The anode foil 6 was formed in the same manner as in the case of the solid electrolytic capacitor A1, except that the etching conditions (more specifically, at least either the etching time or the frequency of the alternating current) were adjusted. 20 solid electrolytic capacitors B2 were produced in the same manner as in the case of the solid electrolytic capacitor A1, except that the obtained anode foil was used.

### [Evaluation]

For each of the solid electrolytic capacitors A2 and B2, the thickness of the core portion 6a, the total thickness of the porous portion 6b, the area percentage of the core portion 6a, and the porosity in the center portion in the thickness direction of the porous portion 6b, near surface layer, and near the core portion were determined using the procedures described above.

Also, the initial capacitance of the solid electrolytic capacitors A1, A2, and B2 was determined using the following procedure.

In an environment of 20° C., the capacitance (μF) of the solid electrolytic capacitor at a frequency of 120 Hz was measured as the initial capacitance (Z₀) (mΩ) using an LCR meter for 4-terminal measurement, and the average value was calculated for 20 samples.

A high temperature test was conducted by placing the solid electrolytic capacitor whose initial capacitance was measured in a 125° C. environment for 1000 hours. After the high temperature test, the capacitance (Z₁)(μF) of the solid electrolytic capacitor was measured in the same manner as Z₀. Then, the rate of change in capacitance was determined using the following formula and used as an index in evaluating the reliability of the solid electrolytic capacitor.

$$rate of change in capacitance = ( {Z}_{1} - {Z}_{0} ) / {Z}_{0} \times 100 ( \% )$$

Note that the closer rate of change in capacitance is to 0%, the less the capacitance changes when exposed to a high temperature environment, indicating that the reliability is excellent.

The evaluation results are shown in Table 2.

TABLE 2

| | A1 | A2 | B2 |
|---|---|---|---|
| Anode foil total thickness (μm) | 108 | 70 | 108 |
| Core portion thickness (μm) | 56 | 30 | 30 |
| Porous portion thickness (μm) | 26 | 20 | 39 |
| Core portion area percentage (%) | 48 | 43 | 28 |
| Porosity near surface layer (%) | 82 | 80 | 78 |
| Porosity in center portion (%) | 76 | 73 | 53 |
| Porosity near core portion (%) | 47 | 49 | 42 |
| Reliability (%) | −4 | −4 | −29 |

As shown in Table 2, in the case where the area percentage of the core portion is as high as 40% or more, when the solid electrolytic capacitor is exposed to a high temperature environment, the change in capacitance is small, and excellent reliability can be ensured. In the solid electrolytic capacitors A1 and A2, the porosity in the center portion in the thickness direction of the porous portion is high, and many voids are formed inside, thus making it possible to ensure a relatively high initial capacitance. By obtaining an appropriate capacitance in the solid electrolytic capacitors A1 and A2, it is possible to ensure excellent charge/discharge response.

Although the present invention has been described using embodiments that are preferred at the present time, such disclosure is not intended to be construed as limiting. Various changes and modifications will no doubt become apparent to those skilled in the art to which the present invention pertains upon reading the above disclosure. It is, therefore, intended that the appended claims be construed as covering all changes and modifications without departing from the true spirit and scope of the present invention.

### INDUSTRIAL APPLICABILITY

According to the present disclosure, a solid electrolytic capacitor having a reduced ESR can be obtained. Also, the solid electrolytic capacitor of the present disclosure has a high charge/discharge response. Additionally, with the solid electrolytic capacitor of the present disclosure, it is possible to suppress a decrease in capacitance even when the solid electrolytic capacitor is exposed to a high temperature. Therefore, the solid electrolytic capacitors can be used in various applications that require high reliability.

### REFERENCE SIGNS LIST

1: solid electrolytic capacitor
2: capacitor element
3: exterior body
4: anode lead terminal
5: cathode lead terminal
6: anode foil
6a: core portion
6b: porous portion
8: cathode portion
9: solid electrolyte layer
10: cathode extraction layer
11: first layer
12: second layer
13: separating portion
14: adhesive layer
I: first portion
II: second portion
Ie: first end portion
IIe: second end portion

1. An electrode foil for a solid electrolytic capacitor, comprising:
a metal foil having a first portion on which a solid electrolyte layer is to be formed and a second portion on which the solid electrolyte layer is not to be formed,
wherein the metal foil includes, in at least the first portion, a porous portion and a core portion continuous with the porous portion, and
in a cross section of the first portion taken in a direction parallel to a thickness direction, a percentage of area occupied by the core portion is 40% or more.

2. The electrode foil for a solid electrolytic capacitor according to claim 1,
wherein in the first portion, a total thickness of the porous portion is 60 μm or less.

3. The electrode foil for a solid electrolytic capacitor according to claim 1,
wherein in the first portion, a thickness of the core portion is 30 μm or more.

4. The electrode foil for a solid electrolytic capacitor according to claim 1,
wherein in the first portion, the porous portion has a porosity of 60% or more and 80% or less in a center portion, with respect to the thickness direction, of the porous portion.

5. A solid electrolytic capacitor element comprising:
the electrode foil for a solid electrolytic capacitor according to claim 1, as an anode foil;
a dielectric layer formed on at least a portion of a surface of the anode foil; and
a cathode portion covering at least a portion of the dielectric layer,
wherein the cathode portion includes, in the first portion, at least the solid electrolyte layer covering at least a portion of the dielectric layer.

6. A solid electrolytic capacitor comprising at least one solid electrolytic capacitor element according to claim 5.
